(19) United States
(12) Patent Application Publication
(10) Pub. No.: US 2021/0259906 A1
(43) Pub. Date: Aug. 26, 2021

(54) Collapsible Travel Crutch

(71) Applicant: Katiuska Rosario-Hernandez, Houston, TX (US)

(72) Inventor: Katiuska Rosario-Hernandez, Houston, TX (US)

(21) Appl. No.: 17/183,514

(22) Filed: Feb. 24, 2021

Related U.S. Application Data
(60) Provisional application No. 62/981,281, filed on Feb. 25, 2020.

(51) Int. Cl. A61H 3/02

(52) U.S. Cl. CPC A61H 3/0288; A61H 2201/0157; A61H 2201/1635; A61H 2201/0161

(57) ABSTRACT

A collapsible travel crutch is defined by an elongated crutch frame. The elongated crutch frame includes an upper portion, a medial portion, and a lower portion. The upper portion has a support member. The lower portion has a ground member. The upper portion is attached to the medial portion, while the medial portion is attached to the lower portion. The collapsible travel crutch is movable between an active configuration and a storage configuration.

### CROSS REFERENCE TO RELATED APPLICATIONS

This application claims the benefit of U.S. Provisional Application No. 62/981,281 filed on Feb. 25, 2020. The above identified patent application is herein incorporated by reference in its entirety to provide continuity of disclosure.

### BACKGROUND OF THE INVENTION

The present invention relates to travel crutches. More specifically, the present invention provides collapsible crutches which provide convenience to crutch users by being more easily storable and transportable.

Crutches are an important mobility assistance device for many people. Typically, crutches include an elongated, stable structure which provides structural support to individuals using them. Most people who use crutches use two crutches, one on each side, to provide sufficient balance and support. Aside from individuals who use crutches full-time, some individuals who are confined to wheelchairs may be required to use crutches in certain scenarios. For example, these individuals may need to utilize crutches when boarding a plane, riding a train, or sightseeing.

One disadvantage associated with crutches is that they do not normally fit into suitcases, backpacks or other carrying cases which most people take with them when they travel. This can be a significant problem in several situations. Particularly, when traveling, luggage restrictions may limit the ability of individuals requiring crutches to carry additional items. This can interfere with the individuals' abilities to carry medication, clothing, or other items.

Therefore, there is a defined need amongst the known prior art references for a new type of crutch that allows for an individual to more easily carry, store and transport crutches in situations where space constraints prevent regular crutches from being used.

### SUMMARY OF THE INVENTION

In view of the foregoing disadvantages inherent in the known types of crutches now present in the prior art, the present invention provides a collapsible travel crutch wherein the same can be utilized for providing convenience for the user when storing and transporting crutches while traveling.

The present system comprises an elongated crutch frame. The elongated crutch frame comprises an upper portion, a medial portion, and a lower portion. The upper portion comprises a support member. The lower portion comprises a ground member. The upper portion is foldably attached to the medial portion. The medial portion is also foldably attached to the lower portion. The collapsible travel crutch is movable between an active configuration and a storage configuration.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of the collapsible travel crutch in an active configuration.

FIG. 2 shows a perspective view of an embodiment of the collapsible travel crutch in a storage configuration.

FIG. 3 shows a close up view of an interface of an embodiment of the collapsible travel crutch.

### DETAILED DESCRIPTION OF THE INVENTION

Reference is made herein to the attached drawings. Like reference numerals are used throughout the drawings to depict like or similar elements of the collapsible travel crutch. The figures are intended for representative purposes only and should not be considered to be limiting in any respect.

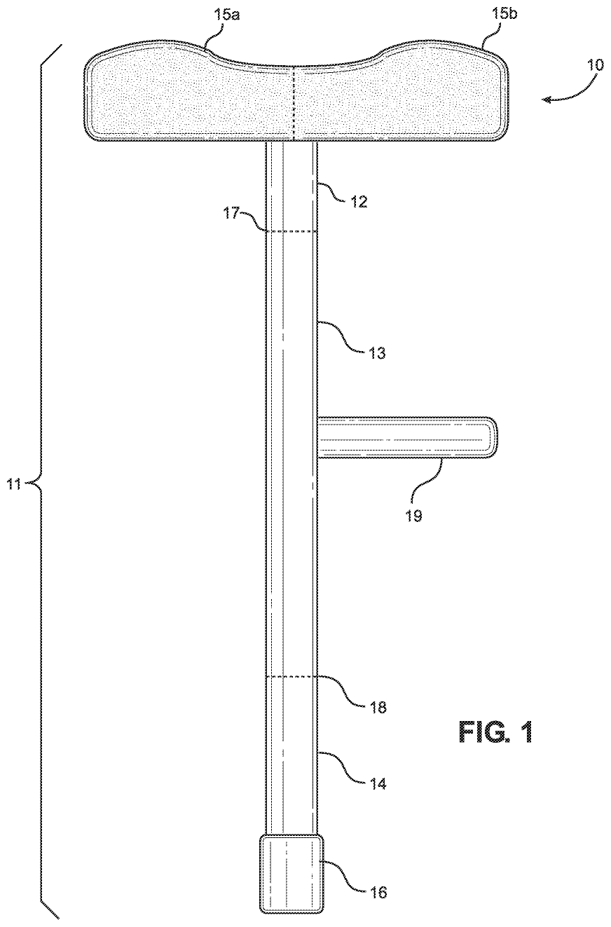

Referring now to FIG. 1, there is shown a side view of an embodiment of the collapsible travel crutch in an active configuration. The collapsible travel crutch 10 comprises an elongated crutch frame 11. The elongated crutch frame 11 is of any suitable size and configuration for providing support to a user. Structurally, the elongated crutch frame 11 must provide sufficient height to extend from the ground to the underarm of the user. Additionally, the elongated crutch frame 11 is made of a durable and lightweight material, such as an aluminum material, so that the collapsible travel crutch 10 will be easy to transport while also being structurally effective for providing support to the user.

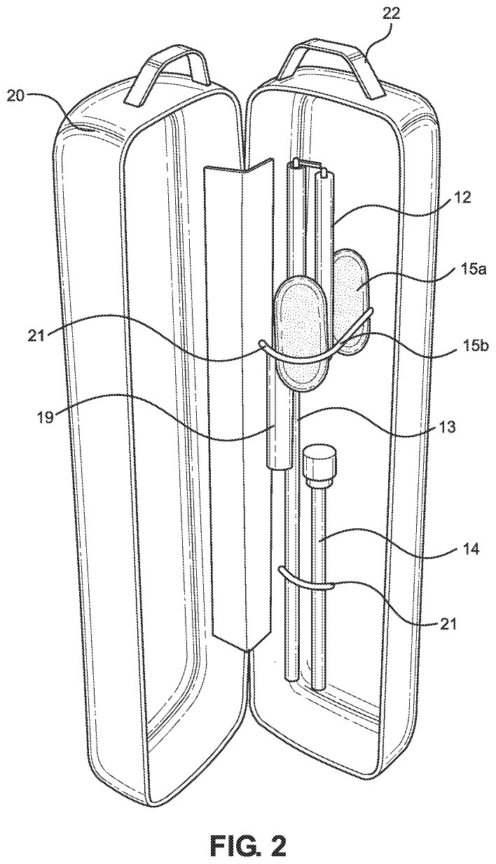

The elongated crutch frame 11 comprises an upper portion 12, a medial portion 13, and a lower portion 14. In the illustrated embodiment, the elongated crutch frame 11 consists of the upper portion 12, the medial portion 13 and the lower portion 14. However, in alternate embodiments, additional intermediate portions may be provided. By providing additional intermediate portions, the user may be able to further collapse the elongated crutch frame 11, such that the collapsible travel crutch 10 will be of a smaller area when placed into a storage configuration (shown in FIG. 2).

In the illustrated embodiment, the upper portion 12 is configured to receive the underarm of the user. As such, the upper portion 12 comprises a support member 15a, 15b. The support member 15a, 15b provides an expanded area on which the user may place his or her weight. The support member 15a, 15b may be cushioned or padded, such as to provide comfort to the user. Alternatively, the support member 15a, 15b may be made of a soft material, such as a rubber material or a silicone material. In the illustrated embodiment, the support member 15a, 15b is collapsible into a pair of support member portions 15a, 15b. As such, the collapsible travel crutch 10 will take up less space in the storage configuration (shown in FIG. 2).

Furthermore, in the demonstrated embodiment, the lower portion 14 comprises a ground member 16. The ground member 16 is configured to engage the ground when the user is utilizing the collapsible travel crutch 10. Ideally, the ground member 16 will be made of a non-slip material, such as a rubber material or a silicone material, such that additional support and stability will be provided to the user.

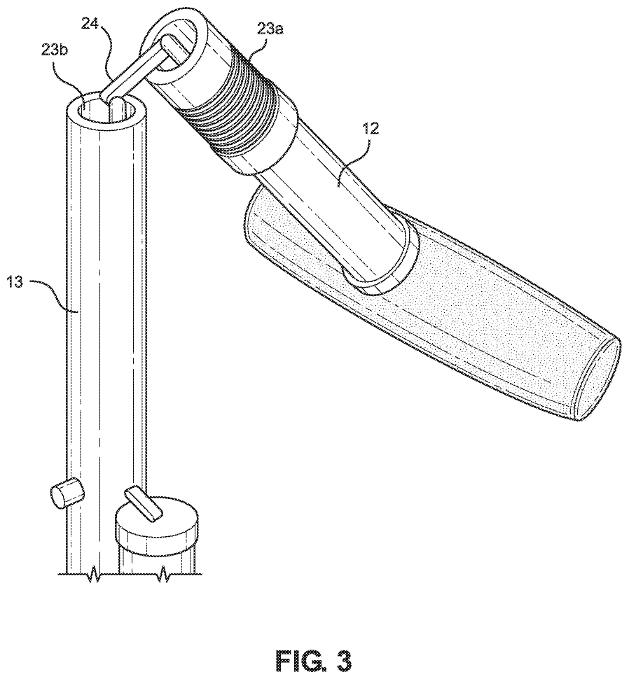

The upper portion 12 is foldably attached to the medial portion 13 at a first interface 17. Furthermore, the medial portion 13 is foldably attached to the medial portion at a second interface 18. In the illustrated embodiment, shown in FIG. 3, the upper portion 12 is joined to the medial portion 13 via a threaded interface and elastic cord, as is the medial portion 13 to the lower portion 14. However, in alternate embodiments, the upper portion 12, medial portion 13, and lower portion 14 may be joined by any suitable means or mechanism.

In the illustrated embodiment, the collapsible travel crutch 10 further comprises a handle grip 19. The handle grip 19 extends laterally from the elongated crutch frame 11. Specifically, in the shown embodiment, the handle grip 19 extends laterally from the medial portion 13 of the elongated crutch frame 11. Ideally, the handle grip 19 will be foldable, such that the handle grip 19 may be folded downward when the collapsible travel crutch 10 is placed into the storage configuration. The handle grip 19 is made of a soft material, such as a rubber material or a silicone material, so that the handle grip 19 will be comfortable for the user to hold.

The demonstrated embodiment of the collapsible travel crutch 10 is shown in the active configuration. The active configuration is defined where the collapsible travel crutch 10 is set up for utilization by the user. Specifically, in the shown embodiment, the active configuration is defined where the upper portion 12 is engaged with the medial portion 13 and the medial portion 13 is engaged with the lower portion 14. Furthermore, the support member 15a, 15b is assembled such that it can receive the underarm of the user thereon. Additionally, in the illustrated embodiment, the handle grip 19 is deployed.

Referring now to FIG. 2, there is shown a perspective view of an embodiment of the collapsible travel crutch in a storage configuration. The storage configuration is defined where the collapsible travel crutch is disassembled, such as to reduce the amount of space that the collapsible travel crutch 10 takes up. Specifically, in the shown embodiment, the storage configuration is defined where the upper portion 12 is disengaged from the medial portion 13 and the medial portion 13 is disengaged from the lower portion 14. Furthermore, in the demonstrated embodiment, the support member 15a/15b is unassembled and folded such that the support member portions 15a, 15b are parallel with the upper portion 12. Additionally, the handle grip 19 is undeployed and parallel with the medial portion 13.

In the illustrated embodiment, the collapsible travel crutch 10 further comprises a case 20. The case 20 is configured to contain the collapsible travel crutch 10 when the collapsible travel crutch 10 is placed into the storage configuration. The case 20 is of any suitable configuration for storing the collapsible travel crutch 10. Specifically, in the demonstrated embodiment, the case 20 is defined by a pair of housing members affixed along a vertical axis via a hinge.

The case 20 may comprise one or more fasteners 21 to assist with storing the collapsible travel crutch 10 within the case 20. In the illustrated embodiment, the fasteners 21 are bands configured to encircle the collapsible travel crutch. Additionally, in the demonstrated embodiment, the case 20 comprises a pair of handles 22 disposed on a top end of the case 20. As such, the case 20 will be more easily carried by the user.

Referring now to FIG. 3, there is shown a close up view of an interface of an embodiment of the collapsible travel crutch. The first interface is shown in the demonstrated embodiment, however, the second interface is of an identical orientation and construction as the first interface and it is therefore submitted that FIG. 3 also demonstrates the form and the operation of the second interface. The first interface of the demonstrated embodiment is defined by a threaded interface 23a, 23b and an elastic rope 24. The threaded interface 23a, 23b is formed through an external threading 23a on the upper portion 12 and a corresponding internal threading 23b on the medial portion 13.

The elastic rope 24 provides tension between the upper portion 12 and the medial portion 13 such as to assist the user in placing the collapsible travel crutch into the active configuration. In use, the user may use the elastic rope 24 to place the upper portion 12 inside of the medial portion 13. Once the upper portion 12 is inserted into the medial portion 13, the user may then rotate the upper portion around a horizontal axis in order to engage the external threading 23a of the upper portion 12 with the internal threading 23b of the medial portion 13.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A collapsible travel crutch, comprising:
an elongated crutch frame;
the elongated crutch frame comprising an upper portion, a medial portion, and a lower portion;
the upper portion comprising a support member;
the lower portion comprising a ground member;
the upper portion foldably attached to the medial portion at a first interface;
the medial portion foldably attached to the lower portion at a second interface;
the collapsible travel crutch movable between an active configuration and a storage configuration.

2) The collapsible travel crutch of claim 1, further comprising a handle grip on the medial portion.

3) The collapsible travel crutch of claim 2, wherein the handle grip is foldable.

4) The collapsible travel crutch of claim 1, further comprising a case, the case dimensioned to receive the collapsible travel crutch when in the storage configuration.

5) The collapsible travel crutch of claim 1, wherein the upper portion is connected to the medial portion by an elastic rope.

6) The collapsible travel crutch of claim 1, wherein the medial portion is connected to the lower portion by an elastic rope.

7) The collapsible travel crutch of claim 1, wherein a threaded interface is defined between the upper portion and the medial portion.

8) The collapsible travel crutch of claim 1, wherein a threaded interface is defined between the medial portion and the lower portion.

9) The collapsible travel crutch of claim 1, wherein the support member is an underarm support member.

10) The collapsible travel crutch of claim 1, wherein elongated crutch frame is made of an aluminum material.

11) The collapsible travel crutch of claim 1, wherein support member is made of a rubber material.

12) The collapsible travel crutch of claim 1, wherein the ground member is made of a rubber material.

13) The collapsible travel crutch of claim 1, wherein the support member is made of a silicone material.

14) The collapsible travel crutch of claim 1, wherein the medial portion is defined by a plurality of medial portion members, the medial portion members being further collapsible.

15) The collapsible travel crutch of claim 2, wherein the handle grip is made of a rubber material.

16) The collapsible travel crutch of claim 2, wherein the handle grip is made of a silicone material.

17) The collapsible travel crutch of claim 1, wherein the support member is collapsible.
